(19) United States
(12) Patent Application Publication
(10) Pub. No.: US 2023/0203873 A1
(43) Pub. Date: Jun. 29, 2023

(54) VEHICLE DOOR OPENING APPARATUS

(71) Applicant: TOYOTA JIDOSHA KABUSHIKI KAISHA, Toyota-shi (JP)

(72) Inventors: Kentaro OYA, Toyota-shi (JP); Chihiro Date, Kariya-shi (JP)

(73) Assignee: TOYOTA JIDOSHA KABUSHIKI KAISHA, Toyota-shi (JP)

(21) Appl. No.: 18/085,780

(22) Filed: Dec. 21, 2022

(30) Foreign Application Priority Data
Dec. 24, 2021 (JP) 2021-210536

(51) Int. Cl. E05F 15/73; B60Q 9/00; B60J 5/06; B60J 5/04

(52) U.S. Cl. CPC E05F 15/73; B60J 5/047; B60J 5/062; B60Q 9/00; E05F 15/659

(57) ABSTRACT

A vehicle door opening apparatus including a door that is electrically openable, an operator operating button and a passenger operating button for a door opening operation, and a BSM for detecting whether a moving object is approaching, in which in a case where the BSM detects that a moving object is approaching, when an opening operation is performed with the operator operating button or the passenger operating button, opening the door is not allowed, and when an emergency opening operation is performed with the operator operating button, opening the door is allowed.

### CROSS REFERENCE TO RELATED APPLICATION

This application claims priority to Japanese Patent Application No. 2021-210536 filed on Dec. 24, 2021, which is incorporated herein by reference in its entirety including the specification, claims, drawings, and abstract.

### TECHNICAL FIELD

The present disclosure relates to a vehicle door opening apparatus having a door that is electrically openable.

### BACKGROUND

Some vehicle door opening apparatuses include a door that is electrically openable. In such a vehicle door opening apparatus, when a moving object approaching the vehicle is detected, even if a door opening operation is performed, the door does not immediately open, so as to prioritize safety. For example, JP 2020-111226 A discloses a technique in which when a moving object approaching a vehicle is detected, the door opening movement is slower than normal.

In such a vehicle door opening apparatus, when a moving object approaching the vehicle is detected, opening the door may not be allowed, in order to prioritize safety. However, such a case could cause a situation in which the door does not open in case of emergency inside the vehicle, such as cases in which fire breaks out, a passenger suddenly becomes ill, and a trouble between passengers occurs.

### SUMMARY

Thus, an aspect of the present disclosure is to provide a vehicle door opening apparatus capable of avoiding a situation in which a door does not open in case of emergency.

A vehicle door opening apparatus according to the present disclosure is a vehicle door opening apparatus including a door that is electrically openable, a door operating unit with which operation to open the door is performed, and a detection unit adapted to detect whether a moving object is approaching, wherein in a case where the detection unit detects that the moving object is approaching, when an opening operation is performed with the door operating unit, opening the door is not allowed, and when an emergency opening operation is performed with the door operating unit, opening the door is allowed.

In this manner, in a case where it is detected that an object is approaching, opening the door with the opening operation is not allowed, but opening the door with the emergency opening operation is allowed, so that a situation in which the door does not open in case of emergency can be avoided.

In the vehicle door opening apparatus according to the present disclosure, the door operating unit includes an operator operating section that is operated by an operator.

In this manner, when the emergency opening operation is performed with the operator operating section, opening the door is allowed, so that the operator who can confirm the safety in the surroundings of the vehicle may open the door, thereby enabling safety to be further secured.

In the vehicle door opening apparatus according to the present disclosure, when the emergency opening operation is performed, opening the door is allowed after an alert is issued to a passenger.

In this manner, safety can be further secured since an alert is issued to a passenger before opening the door.

According to the vehicle door opening apparatus of the present disclosure, a situation in which the door does not open in case of emergency can be avoided, while opening the door is not allowed when a moving object is approaching.

### BRIEF DESCRIPTION OF DRAWINGS

An embodiment of the present disclosure will be described based on the following figures, wherein:

FIG. 1 is a plan view showing a vehicle including a door opening apparatus as an example of an embodiment;

FIG. 2 is a block diagram showing the configuration of the door opening apparatus; and

FIG. 3 is a flowchart showing the flow of a door opening control.

### DESCRIPTION OF EMBODIMENT

Hereinafter, an example of an embodiment of the present disclosure will be described in detail. In the following descriptions, the specific shapes, materials, directions, numerical values, and the like are illustrative examples to facilitate understanding of the present disclosure, and may appropriately be changed in accordance with the application, the purpose, the specification, or the like.

### Vehicle

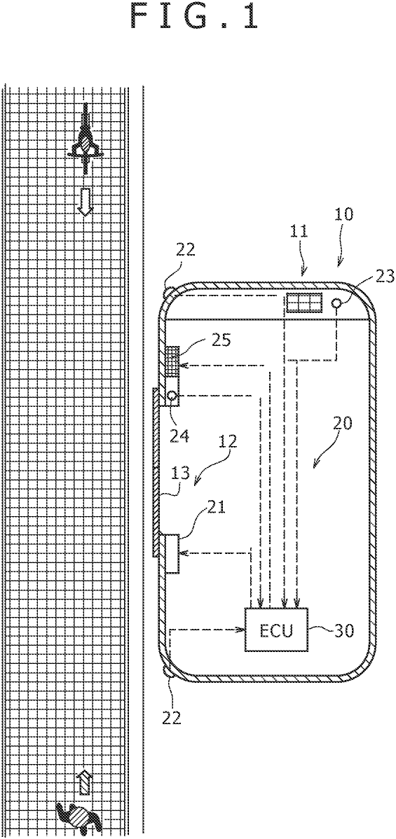

With reference to FIG. 1, a vehicle 10 including a door opening apparatus 20 according to an example of the embodiment will be described.

The vehicle 10 is an electric vehicle in a substantially cuboid that is capable of automatically driving. Specifically, the vehicle 10 is capable of driving in a plurality of operation modes including an automatic driving mode and a manual driving mode.

The vehicle 10 is an electric vehicle driven by a motor as a drive source. Note that the vehicle 10 is not limited to the present embodiment, but may be an engine vehicle driven by an internal combustion engine as a drive source, or a hybrid vehicle using both a motor and an internal combustion engine as a drive source.

The vehicle 10 is used as an omnibus that is shared for a ride by an unspecified large number of passengers. Note that the vehicle 10 is not limited to the present embodiment, but may be used as a retail store where various types of products are displayed for sale, a shop such as a restaurant that cooks and serves food and drink, an office used for clerical work or a meeting with a client, a taxi that transports passengers or baggage, a transportation vehicle, or the like. Further, the setting of the vehicle 10 being used is not limited to business purposes, but the vehicle 10 may also be used as, for example, personal transportation.

As shown in FIG. 1, the vehicle 10 includes operation equipment 11 with which an operator who drives the vehicle 10 operates the vehicle 10 in a manual driving mode, a door 13 for opening a platform 12 provided in a left side portion of the vehicle 10, and the door opening apparatus 20 to open the door 13.

The operation equipment 11 is provided in a front end portion of the vehicle 10. The operator who operates the operation equipment 11 can confirm the surroundings of the vehicle 10 by a rear view mirror, side view mirrors, a camera, and the like (which are not shown). Further, the operation equipment 11 includes an operator operating button 23 of the door opening apparatus 20, which will be described later in detail.

The door 13 is of a sliding double door type that is opened by an electric actuator 21 controlled by the door opening apparatus 20. In the present embodiment, the door 13 is provided in the left side portion of the vehicle 10. The door 13 may be provided in a right side portion or in a rear portion of the vehicle 10, without being restricted by the present embodiment.

### Door Opening Apparatus

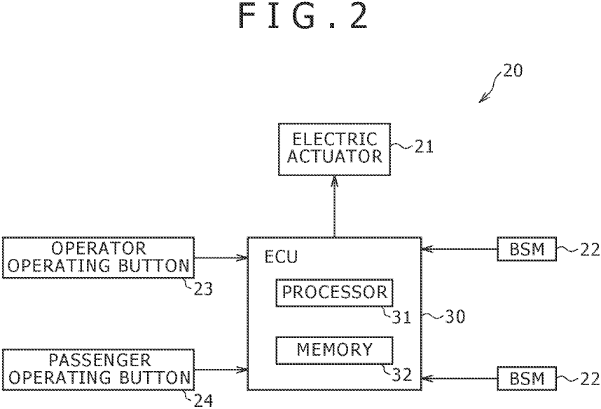

With reference to FIG. 1 and FIG. 2, the door opening apparatus 20 will be described.

The door opening apparatus 20 controls the electric actuator 21 to open the door 13. The door opening apparatus 20 includes the aforementioned electric actuator 21, a blind spot monitor (hereinafter, a BSM) 22 as a detection unit that detects an object approaching the vehicle 10, the operator operating button 23 serving as an operator operating section of the door operating unit included in the operation equipment 11, a passenger operating button 24 as the door operating unit directed toward the vicinity of the door 13 inside the vehicle, a loudspeaker 25 with which a voice alert is issued to a passenger inside the vehicle, and an electronic control unit (ECU) 30 that controls the electric actuator 21 on the basis of a detection signal of the BSM 22 and operation signals of the operator operating button 23 and the passenger operating button 24.

The electric actuator 21 opens the door 13 by a servo motor such that the door 13 slides in each direction of the front and back directions of the vehicle. Note that the electric actuator 21 also operates to close the door 13.

The BSM 22 detects a moving object approaching the vehicle 10. The moving object includes a pedestrian, a bicycle, a motorcycle, an ordinary car, and the like. Further, the moving object also includes an object that is about to pass by the side of the vehicle 10 at a stop. The BSM 22 may be configured so as to emit a millimeter-wave radar to the outside of the vehicle and measure the reflected wave. The BSM 22 is provided in each of the front and rear end portions on the left side of the vehicle 10. The BSM 22 may be provided in the door mirror on the left side, without being restricted by the present embodiment.

The operator operating button 23 is one piece of the operation equipment 11 and is operated to open the door 13 by an operator as a dedicated operator of the vehicle 10 used as a bus.

For the operator operating button 23, two ways of operation are set, which are an “opening operation” performed by a single press of the button and an “emergency opening operation” performed by holding down of the button. Holding down of the button means a state of the button being continuously pressed for a predetermined period of time. The details of the opening behavior of the door 13 with the opening operation and the emergency opening operation will be described later. The emergency opening operation with the operator operating button 23 may also be performed by successive three-time pressing of the button, without being restricted by the present embodiment.

The “emergency opening operation” is a way of operation performed in a case where an emergency situation occurs inside the vehicle 10. The emergency situation is a situation inside the vehicle in which fire breaks out, a person suddenly becomes ill, a trouble between passengers occurs, or the like.

The passenger operating button 24 is a button provided near the door 13 inside the vehicle and is operated to open the door 13 by the passenger inside the vehicle. For the passenger operating button 24, only the way of operation of the “opening operation” performed by a single press of the button is set. For the passenger operating button 24, the emergency opening operation may be set similarly to the operator operating button 23, without being restricted by the present embodiment.

The loudspeaker 25 is provided near the door 13 inside the vehicle and issues a voice alert to the passenger inside the vehicle. The alert includes a warning about a possibility that a moving object approaching the vehicle 10 is passing nearby the platform 12.

The ECU 30 is connected to the electric actuator 21, the BSM 22, the operator operating button 23, the passenger operating button 24, and the loudspeaker 25, and receives a detection signal from the BSM 22 or an operation signal from the operator operating button 23 or the passenger operating button 24 and transmits a control signal to the electric actuator 21 or the loudspeaker 25.

The ECU 30 includes a processor 31 having a CPU and a memory 32 that stores a control program, control data, and the like. The memory 32 is, for example, a RAM, a ROM, and a flash memory. The processor 31 operates in accordance with the control program stored in the memory 32 so as to control the electric actuator 21.

When the opening operation is performed with the operator operating button 23 or the passenger operating button 24 in a normal state (not a state of prohibiting door opening, which will be described later), the processor 31 actuates the electric actuator 21 to open the door 13.

When the BSM 22 detects a moving object approaching the vehicle 10, the processor 31 sets a “state of prohibiting door opening” in which opening the door 13 is not allowed even if the opening operation is performed with the operator operating button 23 or the passenger operating button 24. In this manner, a passenger getting off the vehicle from the platform 12 can avoid being brought into contact with the moving object, thereby securing the safety of the passenger at the time of getting off the vehicle.

When the emergency opening operation is performed with the operator operating button 23 in the “state of prohibiting door opening,” the processor 31 makes an announcement of an alert, using the loudspeaker 25, to the passengers inside the vehicle to warn about a possibility that a moving object approaching the vehicle 10 is passing nearby the platform 12, and then, actuates the electric actuator 21 to open the door 13. In this manner, the safety of the passenger at the time of getting off the vehicle is further secured.

With the door opening apparatus 20, when it is detected that a moving object is approaching, opening the door 13 with the opening operation is not allowed, but opening the door 13 with the emergency opening operation is allowed, so that a situation in which the door 13 does not open in case of emergency can be avoided.

Further, when the emergency opening operation is performed with the operator operating button 23, opening the door 13 is allowed, thereby allowing the operator who can confirm the safety in the surroundings of the vehicle 10 to open the door 13 to thus enable the safety of the passenger at the time of getting off the vehicle to be secured.

### Flow of Door Opening Control

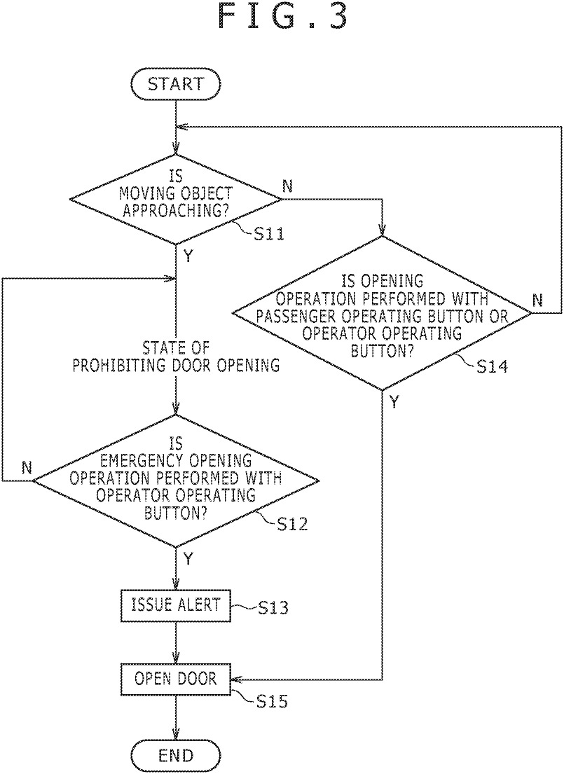

With reference to FIG. 3, the flow of a door opening control performed by the door opening apparatus 20 will be described.

The door opening control starts from the moment when the vehicle 10 is at a stop and the passenger is getting off the vehicle 10. In step S11, the processor 31 confirms whether there is any moving object approaching the vehicle 10, by the BSM 22. When there is an approaching moving object, the “state of prohibiting door opening” is set and the process proceeds to step S12, and when there is no approaching moving object, the process proceeds to step S14.

In step S12, the processor 31 confirms whether the “emergency opening operation” is performed with the operator operating button 23. When the “emergency opening operation” is performed, the process proceeds to step S13. In step S13, the processor 31 makes an announcement of an alert, using the loudspeaker 25, to the passenger inside the vehicle, and the process proceeds to step S15.

In step S14, the processor 31 confirms whether the “opening operation” is performed with the operator operating button 23 or the passenger operating button 24. When the “opening operation” is performed, the process proceeds to step S15. In step S15, the processor 31 actuates the electric actuator 21 to open the door 13.

Note that the present disclosure is not limited to the aforementioned embodiment or the modification thereof, but it goes without saying that various changes and improvements can be made within the scope of the matters recited in the claims of the present application.

1. A vehicle door opening apparatus, comprising:
a door that is electrically openable;
a door operating unit with which operation to open the door is performed; and
a detection unit adapted to detect whether a moving object is approaching, wherein
in a case where the detection unit detects that the moving object is approaching, when an opening operation is performed with the door operating unit, opening the door is not allowed, and when an emergency opening operation is performed with the door operating unit, opening the door is allowed.

2. The vehicle door opening apparatus according to claim 1, wherein the door operating unit comprises an operator operating section that is operated by an operator.

3. The vehicle door opening apparatus according to claim 1, wherein when the emergency opening operation is performed, opening the door is allowed after an alert is issued to a passenger.

4. The vehicle door opening apparatus according to claim 2, wherein when the emergency opening operation is performed, opening the door is allowed after an alert is issued to a passenger.
